(19) United States
(12) Patent Application Publication
(10) Pub. No.: US 2008/0061538 A1
(43) Pub. Date: Mar. 13, 2008

(54) Inflatable vehicle occupant protection device for inboard pelvis protection

(75) Inventors: Masood A. Mohammad, Rochester, MI (US); Ayad G. Nayef, Sterling Heights, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/519,106

(22) Filed: Sep. 11, 2006

(51) Int. Cl. B60R 21/207

(52) U.S. Cl. 280/730.2

(57) ABSTRACT

An apparatus (10) helps protect an occupant (20) of a vehicle (12) that has an occupant seat (22) and a center console (48) positioned adjacent the occupant seat. The apparatus (10) includes an inflatable vehicle occupant protection device (120) inflatable from a stored condition to a deployed condition in which the protection device is inflated and positioned between the occupant (20) of the vehicle seat (22) and the center console (48). An inflation fluid source (122) provides inflation fluid for inflating the protection device (120). In the deployed condition, the protection device (120) has a first end portion (182a) positioned adjacent a seat bottom (24) of the vehicle seat (22) and an opposite second end portion (182b) terminating proximate an upper extent of the occupant's pelvis (152).

### FIELD OF THE INVENTION

The present invention relates to an inflatable apparatus for helping to protect a vehicle occupant in the event of a side impact to the vehicle and/or a vehicle rollover. More particularly, the present invention relates to a side impact air bag inflatable inboard of an occupant to help protect the occupant's pelvis.

### BACKGROUND OF THE INVENTION

It is known to inflate an inflatable vehicle occupant protection device to help protect a vehicle occupant. One particular type of inflatable vehicle occupant protection device is a side impact air bag inflatable between the side structure of the vehicle and a vehicle occupant. Side impact air bags may be stored in a variety of locations in the vehicle, such as the side structure (e.g., a vehicle pillar), seat (e.g., seat bottom or seatback), door, or floor of the vehicle. A side impact air bag may be inflated by inflation fluid directed into the air bag from an inflator.

### SUMMARY OF THE INVENTION

The present invention relates to an apparatus for helping to protect an occupant of a vehicle that has an occupant seat and a center console positioned adjacent the occupant seat. The apparatus includes an inflatable vehicle occupant protection device inflatable from a stored condition to a deployed condition in which the protection device is inflated and positioned between an occupant of the vehicle seat and the center console. An inflation fluid source provides inflation fluid for inflating the protection device. In the deployed condition, the protection device has a lower portion positioned adjacent a seat bottom of the vehicle seat and an upper portion terminating proximate an upper extent of the occupant's pelvis.

The present invention also relates to an apparatus for helping to protect an occupant of a vehicle that has an occupant seat and a center console positioned adjacent the occupant seat. The apparatus includes an inflatable vehicle occupant protection device inflatable from a stored condition to a deployed condition in which the protection device is inflated and positioned between a pelvis of an occupant seated on the vehicle seat and the center console. An inflation fluid source provides inflation fluid for inflating the protection device. The protection device includes a first panel positioned adjacent the center console and a second panel positioned adjacent the occupant when in the deployed condition. The protection device has an inflated thickness measured between the first and second panels when the protection device is in the deployed condition. The inflated thickness is the greatest in a portion of the protection device positioned adjacent an iliac crest of the occupant's pelvis when the protection device is in the deployed condition.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant according to the present invention;

FIG. 2 is a schematic side view taken generally along line 2-2 in FIG. 1; and

FIG. 3 is an enlarged view of a portion of the apparatus of FIG. 1.

### DESCRIPTION OF EMBODIMENTS

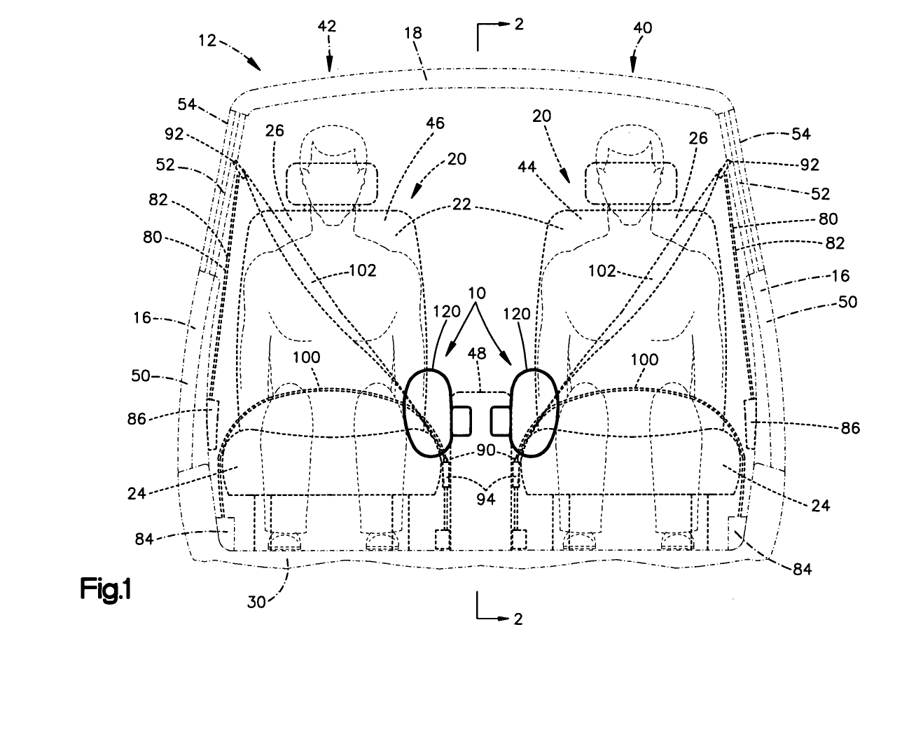

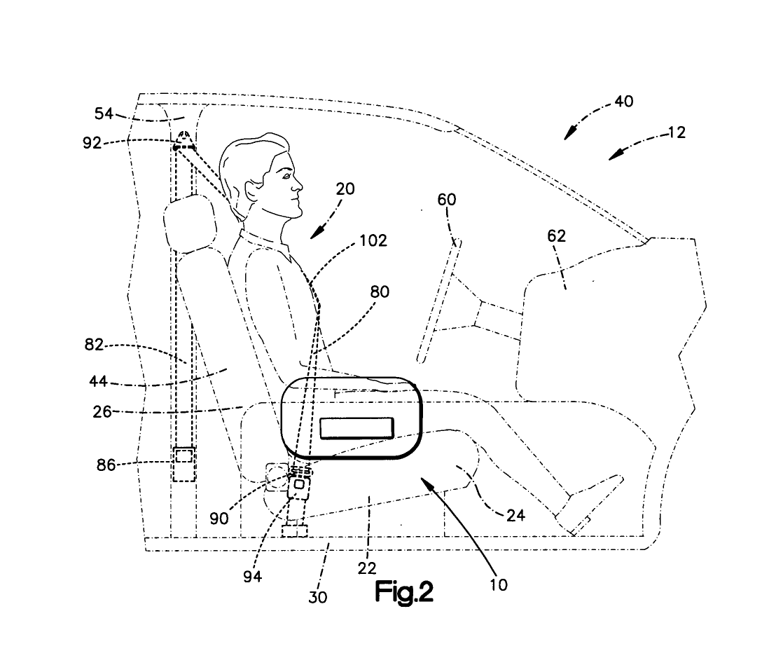

Referring to FIGS. 1 and 2, an apparatus 10 helps protect an occupant 20 of a vehicle 12. According to the present invention, the apparatus 10 includes an inflatable vehicle occupant protection device in the form of a side impact air bag 120 inflatable between the occupant 20 and a center console 48 of the vehicle 12.

FIGS. 1 and 2 illustrate the apparatus 10 configured to help protect occupants 20 in a first or front row of vehicle seats 22. Those skilled in the art, however, will appreciate that the apparatus 10 may be configured to help protect an occupant of any seating row in the vehicle, such as a second or third seating rows. Those skilled in the art will further appreciate that FIG. 1 may be representative of any such seating row in the vehicle 12.

In the embodiment illustrated in FIGS. 1 and 2, the vehicle 12 includes two apparatuses 10. One apparatus 10 helps protect the occupant 20 of the seat 22 on a driver side 40 of the vehicle and one apparatus helps protect the occupant of the seat on a passenger side 42 of the vehicle. For clarity, the present invention is described herein in terms of a single apparatus 10. It should be understood that the following description of the apparatus 10 is applicable to a driver side or passenger side apparatus in any row of passenger seating in the vehicle 12.

The vehicle seats 22 are supported in the vehicle 12 by vehicle structure 30, such as a floor pan. Each of the seats 22 includes a seat bottom portion 24 and a seat back portion 26. The vehicle seats 22 illustrated in FIGS. 1 and 2 are bucket style seats. In this vehicle configuration, the bucket seats 22 are mounted in the vehicle 12 as separate individual components. The present invention could, however, be implemented in a vehicle that includes alternative seating style (not shown), such as bench seating or split-bench seating.

The front row vehicle seats 22 illustrated in FIG. 1 include a driver seat 44 and a passenger seat 46. The center console 48 is positioned between the driver seat 44 and passenger seat 46. The center console 48 may have any known configuration and may include various features, such as storage compartments, auxiliary power outlets, operator controls, and beverage holders, and may include a cushioned surface that serves as an arm rest.

The vehicle 12 includes a side structure 16 on both the driver side 40 and passenger side 42 of the vehicle. A roof 18 extends between the side structures 16. As shown in FIG. 1, the side structures 16 may include a side door 50 including a side window 52. Each of the side structures 16 may also include one or more pillars 54 that help support the roof 18.

FIG. 2 illustrates the driver side 40 of the vehicle 12 and thus shows a steering wheel 60 positioned between the occupant 20 of the driver seat 44 and an instrument panel 62 of the vehicle. It will be appreciated that the passenger side 42 (FIG. 1) would be configured in a manner similar to that shown in FIG. 2, with the steering wheel and other operator controls and instrumentation (not shown) omitted.

The vehicle 12 also includes seatbelts 80 (FIGS. 1 and 2) for helping to protect the occupants 20 in the vehicle seats 22. Each of the seatbelts 80 includes a length of seatbelt webbing 82. One end of the seatbelt webbing 82 is anchored to the vehicle structure 30, e.g., to the floor pan, at an anchor point 84 located adjacent the corresponding vehicle seat 22 on an outboard side of the seat. The anchor point 84 may include, for example, a bracket fastened to the vehicle structure 30 by a threaded fastener.

The end of each length of seatbelt webbing 82 opposite its anchor point 84 is attached to a retractor 86 secured to the vehicle 12 on the outboard side of the corresponding vehicle seat 22. The retractor 86 may, for example, be connected to the side structure 16 of the vehicle 12. Intermediate its ends, each length of seatbelt webbing 82 passes through a tongue assembly 90 and a D-ring 92. The D-ring 92 is secured to structure of the vehicle 12, such as the side structure 16 or, more particularly, one of the pillars 54.

Each seatbelt 80 also includes a buckle 94. The buckles 94 are located on inboard sides of the vehicle seats 22 between the seats and the center console 48. The buckles 94 are secured to the vehicle structure 30 by known means, such as straps or brackets.

When a seatbelt 80 is not in use, its length of seatbelt webbing 82 is wound on the retractor 86 in a known manner. To use the seatbelt 80, the tongue assembly 90 is moved across the vehicle seat 22 and connected with the buckle 94. The seatbelt 80, when in use, includes a lap belt portion 100 and a shoulder belt portion 102. The lap belt portion 100 extends across the lap of the occupant 20 in the area of the upper legs and pelvis of the occupant. The shoulder belt portion 102 extends diagonally across the occupant's torso, from the outboard shoulder of the occupant to adjacent the inboard side of the occupant's lap.

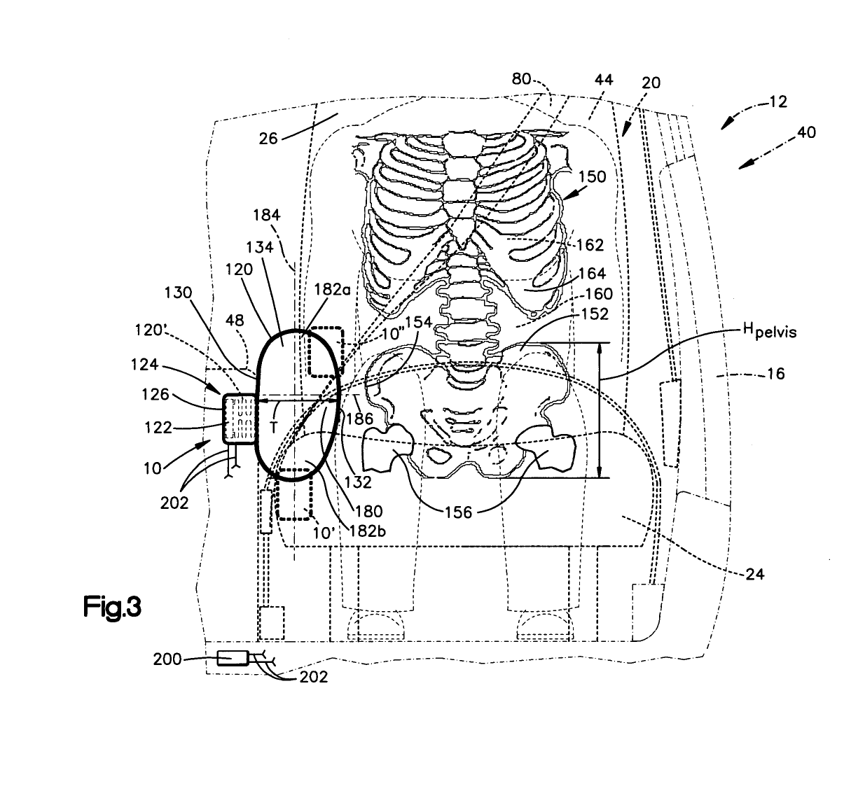

Referring to FIG. 3, the apparatus 10 also includes an inflation fluid source 122, such as an inflator, for providing inflation fluid for inflating the air bag 120. As shown in FIG. 3, the apparatus 10 may take the form of an air bag module 124 that includes the air bag 120, inflator 122, and a housing 126 for supporting the air bag and inflator. In the illustrated embodiment, the apparatus 10, i.e., the air bag module 124, is mounted to the center console 48 of the vehicle 12. Those skilled in the art, however, will appreciate that the apparatus 10 could be mounted at different locations on the vehicle 12. For example, the apparatus 10 could be mounted to the seat bottom portion 24 of the vehicle seat 22, as indicated generally at 10′. As another example, the apparatus 10 could be mounted to the seat back portion 26 of the vehicle seat 22, as indicated generally at 10″.

The inflator 122 may be of any suitable type or construction for supplying a medium for inflating the air bag 120. For example, the inflator 122 may contain a stored quantity of pressurized inflation fluid (not shown) in the form of a gas for inflating the air bag 120. Alternatively, the inflator 122 could contain a combination of pressurized inflation fluid and ignitable material for heating the inflation fluid, or could be a pyrotechnic inflator that uses the combustion of gas-generating material to generate inflation fluid.

The air bag 120 may have a variety of constructions. For example, referring FIG. 3, the air bag 120 may include overlying panels 130 and 132 of material interconnected to help define an inflatable volume 134 of the air bag. The panel 130 is positioned adjacent the center console 48, and the panel 132 is positioned adjacent the occupant 20. The air bag 120 may be formed in a variety of manners, such as by weaving the panels 130 and 132 as a single piece of material, stitching the panels together, or interconnecting the panels via ultrasonic welding, heat bonding, or adhesives.

The air bag 120 may be constructed of any suitable material, such as nylon, and may be uncoated, coated with a gas impermeable material, such as urethane, or laminated with a gas impermeable film. The air bag 120 thus may have a substantially gas-tight construction. Those skilled in the art will appreciate that alternative materials, such as polyester, and alternatives coatings, such as silicone, may also be used to construct the air bag 120.

The vehicle 12 includes a sensor mechanism 200 (shown schematically in FIG. 3) for sensing the occurrence of an event for which inflation of the air bag 120 is desired, such as a side impact to the vehicle 12 and/or a vehicle rollover. Upon sensing the occurrence of such an event, the sensor mechanism 200 provides an electrical signal over lead wires 202 to the inflator 122. The electrical signal causes the inflator 122 to be actuated in a known manner. The inflator 122, when actuated, discharges fluid under pressure into the air bag 120.

The air bag 120 inflates under the pressure of the inflation fluid from the inflator 122. The air bag 120 deploys from the stored condition in the housing 126 (illustrated generally in dashed lines at 120′ in FIG. 3) to the deployed position (illustrated in solid lines in FIGS. 1-3). The air bag 120, when inflated, is positioned between the center console 48 and the occupant 20 of the vehicle 12. The air bag 120, when inflated, helps to absorb the energy of impacts with the air bag and helps to distribute the impact energy over the area of the air bag.

FIG. 3 illustrates a skeletal system 150 of the occupant 20. Referring to FIG. 3, the skeletal system 150 includes a pelvis 152. The pelvis 152 presents a relatively wide and contiguous bone structure positioned between the side structure 16 of the vehicle 12 and the center console 48. According to the present invention, the air bag 120 helps protect the occupant 20 by providing inflatable protection between the center console 48 and the occupant's pelvis 152.

The size, extent, and coverage of the air bag 120 in the vehicle 12 is selected so as to provide a desired coverage of the center console 48 adjacent the occupant 20. This may be done with reference to an occupant sized according to statistical physical parameters, such as height, weight, or both, so as to achieve a desired percentage of the population for which the air bag helps provide coverage.

For example, the size and coverage of the air bag 120 may be established with reference to statistical physical parameters belonging to what is referred to as a 95^{th} percentile male occupant. A 95^{th} percentile male has physical parameters that, statistically, are equal to or greater than the physical parameters of 95% of the general male population. For example, in terms of height, a 95^{th} percentile male may have a height equal to or greater than 73 inches. As another example, in terms of weight, a 95^{th} percentile male may have a weight equal to or greater than 213 pounds. A 95^{th} percentile male occupant is thus a relatively large male occupant.

The size and coverage of the air bag 120 may be established with reference to statistical physical parameters belonging to what is referred to as a 5^{th} percentile female occupant. A 5^{th} percentile female has physical parameters that, statistically, are equal to or greater than the physical parameters of the smallest 5% of the general female population. For example, in terms of height, a 5^{th} percentile female may have a height equal to or greater than 59 inches. As another example, in terms of weight, a 5^{th} percentile female may have a weight equal to or greater than 108 pounds. A 5^{th} percentile female occupant is thus a relatively small female occupant. The air bag 120 thus may be designed to have a size, extent, and coverage for occupants ranging from the 5^{th} percentile female to the 95^{th} percentile male.

The coverage of the air bag 120 also takes into account the various positions in the vehicle 12 to which the vehicle seats 22, and thus the occupants 20, can be adjusted. For example, the vehicle seats 22 have positions that can be adjusted in directions such as fore and aft, up and down, by being tilted (about a pivot axis), or in a combination of these directions. In this instance, the coverage of the air bag 120 for a center console mounted apparatus 10 can take into account the various possible positions of the vehicle occupants 20 as affected by the seat position. Similarly, for the apparatus 10′ mounted to the seat bottom 24 or the apparatus 10″ mounted to the seat back 26, coverage of the air bag may need to be extended to account only for tilted (e.g., reclined) positions of the seat back 26, since the apparatuses move fore and aft and up and down with the vehicle seat 22. The coverage of the air bag 120 can further take into account the configuration of the apparatus 10 and the construction or architecture of the vehicle.

The size, extent, and coverage of the air bag 120 is selected to help protect the pelvis 152 and the pelvic region for occupants 20 ranging in size from the 5^{th} percentile female to the 95^{th} percentile male. The occupant 20 has a pelvis height indicated generally at Hₚₑₗᵥᵢₛ in FIG. 3. For example, the pelvis height Hₚₑₗᵥᵢₛ for the 95^{th} percentile male may be about 10 inches and the pelvis height Hₚₑₗᵥᵢₛ for the 5^{th} percentile female may be about 7.5 inches. The air bag 120 may thus be sized and configured to cover the larger male pelvis height and thus help protect both the 95^{th} percentile male and 5^{th} percentile female occupant.

The air bag 120 is configured to extend vertically from adjacent the lower extent of the occupant's pelvis 152 and femur 156 to proximate the upper extent of the occupant's pelvis. By “proximate” the upper extent of the occupant's pelvis 152, it is meant that the air bag 120 is configured to extend to adjacent or slightly above the upper extent of the occupant's pelvis, e.g., above the upper extent of the occupant's pelvis and below the occupant's ribcage 164. As shown in FIG. 2, when the occupant 20 is in a normally seated and belted condition, the architecture of the vehicle 12 and the vehicle seat 22 may dictate that the occupant is slightly reclined. Because of this, an upper end portion 182a of the air bag 120 may be positioned adjacent the occupant's abdomen 160, beneath the occupant's thorax 162 and ribcage 164.

The air bag 120 has an inflated thickness measured between the overlying panels 130 and 132 when the air bag is in the inflated and deployed condition. The inflated thickness at one particular location on the air bag 120 is indicated generally at T in FIG. 3. The air bag 120 when inflated has a generally oblong and rounded configuration in which a central portion 180 of the air bag has an inflated thickness greater than the thickness of the upper end portion 182a and an opposite lower end portion 182b of the air bag.

To assist in this description, reference is made herein to a major axis 184 and a minor axis 186 of the air bag 120. The major axis 184 extends along the major or longer dimension of the elongated configuration of the air bag 12 as viewed in cross section in FIG. 3. The major axis 184 thus extends generally vertically in the vehicle 12 as viewed in FIG. 3. The minor axis 186 extends parallel to the direction in which the inflated thickness of the air bag 120 is measured. The minor axis 186 extends generally laterally in the vehicle 12, perpendicular to the major axis 184 and perpendicular to the direction of forward vehicle travel. The inflated thickness of the air bag 120 is measured parallel to the minor axis 186.

The minor axis 186 is located at or in close proximity to the point or location in the central portion 180 where the inflated thickness of the air bag 120 is the greatest. As shown in FIG. 3, the apparatus 10 is configured such that the minor axis 186 of the air bag 120 is aligned with the occupant's pelvis 152. As viewed in FIG. 3, the central portion 180 and the minor axis 186 are aligned with a portion of the pelvis 152 where the pelvis is widest, referred to as the iliac crest 154 of the pelvis. The apparatus 10 is thus configured such that the portion of the air bag 120 positioned adjacent the widest portion of the occupant's pelvis 154 is also the portion of the air bag 120 where the inflated thickness is the greatest.

Because the air bag 120 helps protect the occupant's pelvis 152 and the regions of the occupant 20 in the vicinity of the pelvis, the air bag 120 may be pressurized in accordance with the ability of the pelvis and pelvic region to withstand impact forces and the susceptibility of pelvis and pelvic region to injury as a result of the impact forces. The air bag 120 may also be pressurized in accordance with conditions unique to the purpose of helping to protect the pelvis 152 in a vehicle architecture that includes a center console 48. In the vehicle architecture including the center console 48, there is less room or space within which side impact forces, rollover forces, or both may be cushioned or absorbed. As shown in FIG. 1, the pelvis 152 is positioned between the side structure 16 and the center console 48. The pelvis 152 is thus positioned in relatively close proximity with vehicle structure both inboard and outboard of the occupant 20. Portions of the occupant 20 positioned above the center console 48, such as the abdomen 160 and thorax 162, are not positioned adjacent vehicle structure inboard of the occupant 20.

In general, the pelvis 152 can withstand impact forces greater than those that other regions of the human body, such as an abdomen 160 or thorax 162, can withstand. Because of this, those skilled in the art will appreciate that it may be desirable to inflate an air bag that covers the pelvis 152 to a pressure that is elevated with respect to the pressure to which air bags covering other portions of the occupant 20 are inflated. The configuration of the air bag 120, being selected to cover the occupant's pelvis 152, is suited for such pressurization to help protect the occupant's pelvis.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for helping to protect an occupant of a vehicle that has an occupant seat and a center console positioned adjacent the occupant seat, the apparatus comprising:
an inflatable vehicle occupant protection device inflatable from a stored condition to a deployed condition in which the protection device is inflated and positioned between an occupant of the vehicle seat and the center console; and
an inflation fluid source for providing inflation fluid for inflating the protection device;
the protection device when in the deployed condition having a first end portion positioned adjacent a seat bottom of the vehicle seat and an opposite second end portion terminating proximate an upper extent of the occupant's pelvis.

2. The apparatus recited in claim 1, wherein the protection device has an inflated thickness when in the deployed condition, the inflated thickness of the protection device being greatest adjacent a widest portion of the occupant's pelvis.

3. The apparatus recited in claim 1, wherein the protection device has an inflated thickness when in the deployed condition, the inflated thickness of the protection device being greatest adjacent an iliac crest of the occupant's pelvis.

4. The apparatus recited in claim 1, wherein the upper portion of the protection device terminates above an iliac crest of the occupant's pelvis.

5. The apparatus recited in claim 1, wherein the protection device when in the deployed condition has a major axis extending vertically in the vehicle and a minor axis extending laterally in the vehicle perpendicular to the major axis, the protection device being configured such that the minor axis is aligned with an iliac crest of the occupant's pelvis when the protection device is in the deployed condition.

6. The apparatus recited in claim 5, wherein the protection device has an inflated thickness measured parallel to the minor axis when the protection device is in the deployed condition, the minor axis extending through a portion of the protection device where the inflated thickness is the greatest.

7. The apparatus recited in claim 1, wherein the protection device when in the stored condition is located in a seat bottom of the occupant seat.

8. The apparatus recited in claim 1, wherein the protection device when in the stored condition is located in the center console.

9. The apparatus recited in claim 1, wherein the protection device when in the stored condition is located in a seat back of the occupant seat.

10. An apparatus for helping to protect an occupant of a vehicle that has an occupant seat and a center console positioned adjacent the occupant seat, the apparatus comprising:
an inflatable vehicle occupant protection device inflatable from a stored condition to a deployed condition in which the protection device is inflated and positioned between a pelvis of an occupant seated on the vehicle seat and the center console; and
an inflation fluid source for providing inflation fluid for inflating the protection device;
the protection device comprising a first panel positioned adjacent the center console and a second panel positioned adjacent the occupant when in the deployed condition, the protection device having an inflated thickness measured between the first and second panels when the protection device is in the deployed condition, the inflated thickness being the greatest in a portion of the protection device positioned adjacent an iliac crest of the occupant's pelvis when the protection device is in the deployed condition.

11. The apparatus recited in claim 10, wherein the protection device when in the deployed condition has a major axis extending vertically in the vehicle and a minor axis extending perpendicular to the major axis, the inflated thickness of the protection device being measured parallel to the minor axis, the minor axis being aligned with the iliac crest of the occupant's pelvis when the protection device is in the deployed condition.

12. The apparatus recited in claim 11, wherein the minor axis extends through a portion of the protection device where the inflated thickness is greatest.

13. The apparatus recited in claim 10, wherein the protection device when in the stored condition is located in a seat bottom of the occupant seat.

14. The apparatus recited in claim 10, wherein the protection device when in the stored condition is located in the center console.

15. The apparatus recited in claim 10, wherein the protection device when in the stored condition is located in a seat back of the occupant seat.

16. An apparatus for helping to protect an occupant of a vehicle that has a center console positioned between two vehicle seats, the center console projecting up at least to upper surfaces of seat bottoms of the vehicle seats, the apparatus comprising:
at least one inflatable vehicle occupant protection device inflatable from a stored condition to a deployed condition in which the at least one protection device is inflated and positioned between an occupant of the vehicle seat and the center console; and
an inflation fluid source for providing inflation fluid for inflating the at least one protection device;
the at least one protection device when in the deployed condition having a first end portion positioned below the upper surfaces of the seat bottoms and an opposite second end portion positioned above the upper surfaces of the seat bottoms.

17. The apparatus recited in claim 16, wherein the at least one protection device comprises:
a first inflatable vehicle occupant protection device having a deployed condition in which the protection device is inflated and positioned between an occupant of the first vehicle seat and the center console; and
a second inflatable vehicle occupant protection device having a deployed condition in which the protection device is inflated and positioned between an occupant of the second vehicle seat and the center console.
